(19) United States
(12) Patent Application Publication
(10) Pub. No.: US 2011/0239481 A1
(43) Pub. Date: Oct. 6, 2011

(54) Cup Sleeve

(76) Inventor: Raymond A. Ray, Duarte, CA (US)

(21) Appl. No.: 12/753,030

(22) Filed: Apr. 1, 2010

(51) Int. Cl. F26B 5/12; B65D 25/00

(52) U.S. Cl. 34/353; 220/737

(57) ABSTRACT

Methods and apparatus for absorbing condensation on beverage cups are provided. The apparatus consists of an inner layer of absorbent material fixed or bonded to an outer layer of non-absorbent material. The two layers are formed into a cylindrical sleeve, which is then placed over the outside of a beverage cup.

### BACKGROUND

1. Field

The present disclosure relates generally to beverage container devices, and in particular, to a cup sleeve for beverage containers.

2. Background

Consumers of cold beverages have been faced with a frustrating problem, that of condensation on the outside of the cup or glass. This is particularly pronounced with iced beverages. In effect, the glass or cup “sweats” moisture on the external surface of the container. This moisture becomes bothersome if the cup is left on furniture, potentially creating a ring or water spot. Consumers on the go also face problems.

Hands may become cold while holding a cold drink and the grip on the container may slip due to the moisture on the outside of the container. This may cause the consumer to drop the container, spilling the beverage. At best, the consumer only gets wet hands. Holding onto the lid does not solve the problem, since many lids may not be firmly attached to the cup and a full cup weight of beverage may overcome the retaining power of the press fit lid, once again causing a spill.

Many beverages are purchased “on the go” or while consumers are driving or traveling. In many cases, bringing a separate holder for a beverage cup is not foremost in the user's mind. Such cup holders are forgotten and left behind at home or elsewhere. Even if brought along, the typical cup holder does nothing to solve the problem of condensation on the outside of the cup. More permanent cup holders are often made of plastic or other non-biodegradable materials, further contributing to waste disposal problems. In most cases, the cup holders do nothing to absorb the condensation forming on the cup.

There is a need in the art for a cup sleeve made of absorbent material designed to absorb the condensation on the external surface of a beverage container while keeping the user's hand dry.

### SUMMARY

A cup sleeve that absorbs condensation formed on beverage cups is provided. The cup sleeve is comprised of an outer layer of non-absorbent material. This outer layer is bonded to an inner layer of absorbent material. The two layers are then formed into a cylindrical shape and the ends are secured. In use, the inner absorbent material is placed in contact with the exterior surface of the beverage cup. The user holds the cup sleeve and the user's hand is in contact with the non-absorbent outer layer of the cup sleeve.

A method of absorbing condensation on a beverage cup is provided. The cup is first filled with a beverage. Next a cup sleeve is placed on an outer surface of the beverage cup with the inner layer in contact with the exterior surface of the beverage cup.

An apparatus for absorbing condensation on a beverage cup is provided. The apparatus includes means for non-absorption of condensation on a an outer layer; means for absorption of condensation on an inner layer, the means for absorption of condensation on an inner layer attached to the means for non-absorption on an outer layer and formed into a cylinder, the cylinder placed over an exterior surface of the beverage cup wherein the inner layer is in contact with the exterior surface of the beverage cup.

In one embodiment the inner layer may be made of biodegradable material. In a further embodiment, both the inner and outer layers are made of biodegradable material.

Various aspects and embodiments of the invention are described in further detail below.

### BRIEF DESCRIPTION OF THE DRAWINGS

FIG. 1 is an illustration of a beverage container equipped with a cup sleeve, in accordance with various embodiments of the present invention.

FIG. 2 is an illustration of the top view of a cup sleeve in unassembled condition, in accordance with one or more embodiments the present invention.

FIG. 3 is an illustration of a side view of a cup sleeve in unassembled condition, according to one or more embodiments of the present invention.

FIG. 4 is an illustration of a top view of a cup equipped with a cup sleeve, according to one or more embodiments of the present invention.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

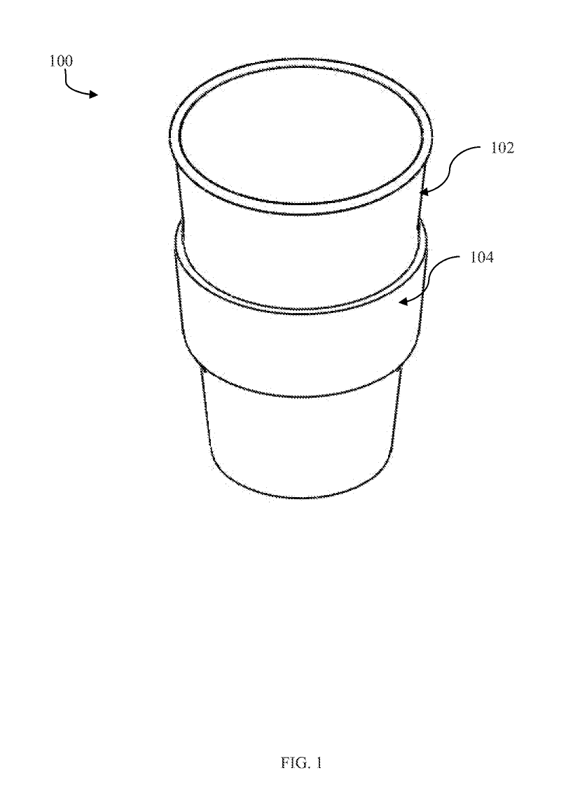

FIG. 1 illustrates a beverage cup and cup sleeve assembly 100. The cup sleeve 104 encircles the beverage cup 102. The cup sleeve is sized to accept standard disposable beverage cups of the type typically used for iced or cold beverages. Different sizes, having different diameters may be available for the various sized of cups. The cup sleeve 104 is cylindrical and is sized and placed where a consumer would normally grasp the cup.

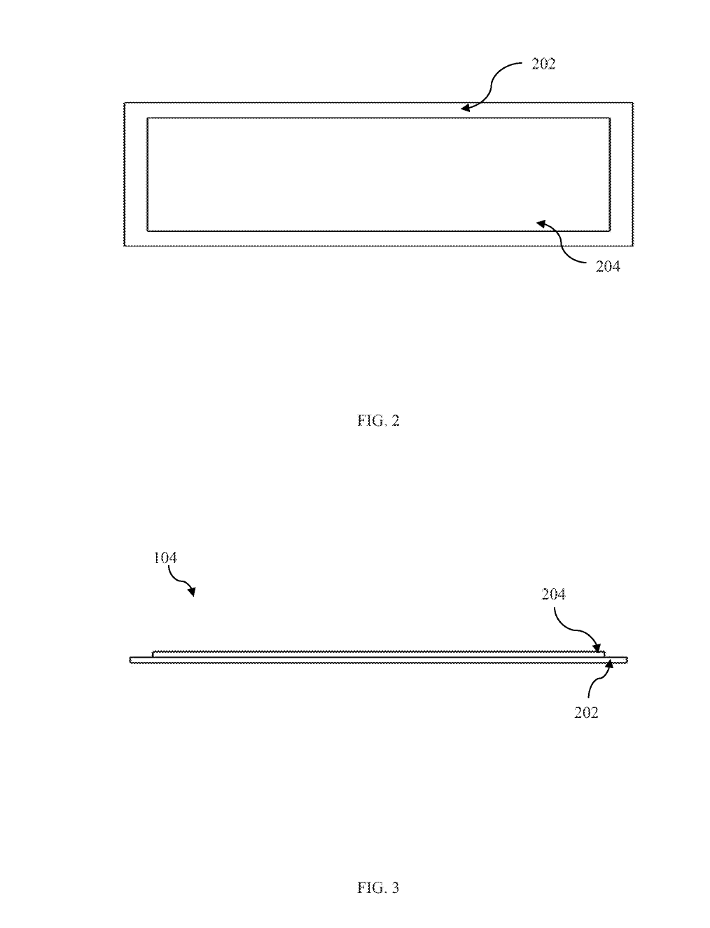

FIG. 2 illustrates the cup sleeve in unassembled, or flat condition. The cup sleeve 104 is comprised of two layers of material. The outer layer 202 is in contact with the consumer's hand. Outer layer 202 is non-absorbent material and may be textured to aid in grasping the cup. Outer layer 202 may be biodegradable. Outer layer 202 prevents the consumer's hand from coming into contact with the condensation forming on the cup as the beverage is consumed.

Inner layer 204 is an absorbent material and may also be biodegradable. Inner layer 204 absorbs the condensation forming on the cup and wicks the moisture away from the surface of the cup. This material retains the condensation and in conjunction with outer layer 202 allows the user to hold the beverage without being troubled by the condensing moisture.

The outer layer 202 and inner layer 204 may bonded together using a variety of bonding means including adhesives, pressure bonding, and heat sealing, or other means. The means selected should not alter the properties of either the inner or outer layers.

FIG. 3 shows a side view of the cup sleeve after bonding. The outer layer 202 is below inner layer 204 and the layers have been bonded together. The cup sleeve may be of varying thickness, depending on the absorbent material selected for inner layer 204.

Once the inner layer 204 and outer layer 202 have been bonded together the cup sleeve may be formed. The cup sleeves may be any desired height but will typically be less than the height of the cup the cup sleeves will be used with. The cup sleeves are cut to the desired height and are formed into hollow cylinders with the ends bonded together. The edges may overlap. The ends of the cup sleeve 104 may also be fastened with interlocking slits in lieu of bonding. An extension of the outer layer 202 may also allow for an overlap, with the ends of inner layer 204 butted together.

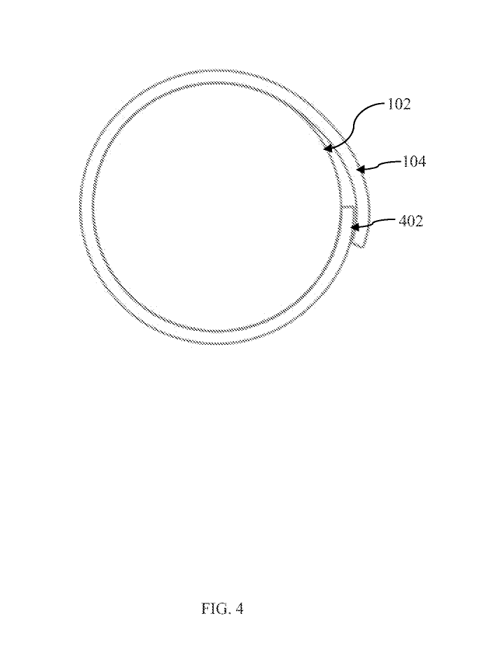

FIG. 4 illustrates the formed and ready for use cup sleeve 104 applied to a beverage cup 102. The ends are overlapped, as shown at item 402. The inner layer 204 is placed against the beverage cup surface, while outer layer 202 faces outward.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A cup sleeve, comprising:
an outer layer of non-absorbent material;
an inner layer of absorbent material attached to the outer layer of non-absorbent material;
the outer layer and the inner layer attached to the outer layer formed into a cylindrical shape and ends secured.

2. The cup sleeve of claim 1, wherein the outer layer material is biodegradable.

3. The cup sleeve of claim 1, where the inner layer material is biodegradable.

4. The cup sleeve of claim 1, where the outer layer material and the inner layer material are biodegradable.

5. The cup sleeve of claim 1, where the ends are secured by overlapping.

6. The cup sleeve of claim 1, where the ends are secured by interlocking slits.

7. A method of absorbing condensation on a beverage cup, comprising;
placing a beverage in the beverage cup;
placing a cup sleeve on an outer surface of the beverage cup; and
absorbing condensation on the outer surface of the beverage cup with the cup sleeve.

8. An apparatus for absorbing condensation on a beverage cup, comprising:
means for non-absorption of condensation on an outer layer;
means for absorption of condensation on an inner layer, the means for absorption of condensation on an inner layer attached to the means for non-absorption on an outer layer and formed into a cylinder, the cylinder placed over an exterior surface of the beverage cup wherein the inner layer is in contact with the exterior surface of the beverage cup.
